(19) United States
(12) Patent Application Publication
(10) Pub. No.: US 2005/0271946 A1
(43) Pub. Date: Dec. 8, 2005

(54) Positive electrode current collector for a manganese dry battery and a manganese dry battery using the same

(76) Inventor: Hajime Murakami, Kishiwada-shi (JP)

Correspondence Address: MCDERMOTT WILL & EMERY LLP, 600 13TH STREET, N.W., WASHINGTON, DC, 20005-3096, US

(21) Appl. No.: 10/533,951

(22) PCT Filed: May 26, 2004
(86) PCT No.: PCT/JP04/07585

§ 371 Date: May 4, 2005

(30) Foreign Application Priority Data
Jul. 4, 2003 (JP) 2003-192170

(51) Int. Cl. H01M 4/66; H01M 4/75; H01B 1/24; H01M 2/26

(52) U.S. Cl. 429/245; 429/238; 252/510; 429/161

(57) ABSTRACT

To provide a positive electrode current collector for a manganese dry battery including a carbon rod with a low density yet with good retention of the sealing property of the battery during high temperature storage. The positive electrode current collector for a manganese dry battery comprises a carbon rod and paraffin wax containing a hydrocarbon compound having a molecular weight of 300 to 500 impregnated in the carbon rod, the paraffin wax containing a hydrocarbon compound having a molecular weight of not greater than 310 in an amount of not greater than 0.5 wt %.

### TECHNICAL FIELD

The present invention relates to a positive electrode current collector for a manganese dry battery comprising a carbon rod, and a manganese dry battery using the same.

### BACKGROUND ART

A carbon rod having been used for a positive electrode current collector of a manganese dry battery is porous. In order to prevent air from entering the battery through the pores, the carbon rod is usually impregnated with wax.

Conventionally, 135° F. paraffin wax has been used as wax with a low melting point. This paraffin wax usually contains several percent of a component that melts at 45° C. or lower. Since manganese dry batteries might be exposed to a temperature of 45° C. or higher during transportation or storage, storage tests are usually performed at 45° C. The storage tests include: durability test during high temperature storage, and accelerated evaluation in which durability during long-term storage at room temperature is evaluated in a shortened period of time. For this reason, the use of paraffin wax containing a component that melts at 45° C. is not preferred. Carbon rods having been used have a high density and thus only a small amount of paraffin wax is required for the impregnation, so that there is little effect on the sealing property of the battery due to the melting of the paraffin wax as long as carbon rods with a high density are used.

However, in the case of using a carbon rod with a low density as the carbon rod for a manganese dry battery with the aim of rationalization such as cost reduction, the carbon rod with a low density have a high porosity and thus a large amount of paraffin wax to be impregnated is required. Therefore, a large amount of paraffin wax will be melt during storage at 45° C. and problems arise such as melting of a sealant resulting from the melted paraffin wax and sealing failure of the battery resulting from the melting of a sealant.

One possible way to solve the above problems is to use paraffin wax with a high melting point. Japanese Laid-Open Patent Publication No. Hei 3-297063, for example, proposes a method for preventing the component of an impregnating agent containing paraffin wax from seeping out during high temperature storage by setting the melting point of the impregnating agent to 90° C. or higher.

Among paraffin wax with a high melting point, some of the paraffin wax contains a component that melts at 45° C. or lower depending on production areas of the raw material and production methods, so that the sealing property of the battery might be reduced during high temperature storage even when paraffin wax with a high melting point is used.

### DISCLOSURE OF INVENTION

Thus, in order to solve the above problems, an object of the present invention is to provide a positive electrode current collector for a manganese dry battery including a carbon rod with a low density yet with good retention of the sealing property of the battery during high temperature storage. Another object of the present invention is to provide a manganese dry battery having high temperature storage characteristics by using the above positive electrode current collector.

In order to solve the above problems, the positive electrode current collector for a manganese dry battery of the present invention comprises a carbon rod and paraffin wax containing a hydrocarbon compound having a molecular weight of 300 to 500 impregnated in the carbon rod, wherein the amount of a hydrocarbon compound having a molecular weight of not greater than 310 in the paraffin wax is not greater than 0.5 wt %.

The amount of the hydrocarbon compound having a molecular weight of not greater than 310 in the paraffin is preferably measured by gas chromatography.

The carbon rod preferably has a density of 1.50 to 1.75 g/cm³.

Polybutene is preferably applied as a sealant in the manganese dry battery.

The manganese dry battery of the present invention preferably comprises the aforesaid positive electrode current collector.

More preferably, the manganese dry battery of the present invention further comprises a sealing member having an aperture for fitting the positive electrode current collector therein, and polybutene is placed as a sealant in the fitting portion between the positive electrode current collector and the sealing member.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a front view, partly in cross section, of a manganese dry battery in accordance with the present invention.

### BEST MODE FOR CARRYING OUT THE INVENTION

The positive electrode current collector for a manganese dry battery of the present invention comprises a carbon rod impregnated with paraffin wax, which contains a hydrocarbon compound having a molecular weight of 300 to 500. Further, the amount of the hydrocarbon compound having a molecular weight of not greater than 310 in the paraffin wax is not greater than 0.5 wt %.

The main feature of the present invention lies in the use of specific paraffin wax as the wax to be impregnated in the carbon rod as described above, so that even a battery comprising a carbon rod with a low density can retain the sealing property thereof.

The paraffin wax that can be used in the present invention is required to contain 0 to 0.5 wt % of a hydrocarbon compound having a molecular weight of not greater than 310, which is a component that melts at 45° C., in consideration of the battery to be produced being stored at 45° C. during the evaluation of battery characteristics.

This is because, if the amount of the hydrocarbon compound having a molecular weight of not greater than 310 exceeds 0.5 wt %, the amount of the paraffin wax melted from the carbon rod at 45° C. or lower will be increased, likely to cause the melting of the sealant.

An example of the method for determining the amount of the hydrocarbon compound having a molecular weight of not greater than 310 that melts at 45° C. or lower in the paraffin wax is gas chromatography.

The carbon rod used in the present invention preferably has a density of 1.50 to 1.75 g/cm³, more preferably a low density of 1.50 to 1.65 g/cm³. Even a carbon rod with such low density can minimize the melting of the paraffin wax and the reduction of sealing property if the carbon rod is impregnated with the paraffin wax described above.

The carbon rod may be prepared by a conventional method, or it may be a commercially available carbon rod. The carbon rod can be prepared, for example, by extruding a mixture of graphite and a binder such as pitch in a rod. The impregnation of the carbon rod with the paraffin wax may be done by a conventional method.

By impregnating the carbon rod with the paraffin wax as described above, it is possible to produce a positive electrode current collector of the present invention.

Moreover, with the use of the positive electrode current collector, a manganese dry battery with excellent sealing property can be produced by a conventional method.

In the manganese dry battery, a sealing member having an aperture for fitting the positive electrode therein is provided in order to seal the battery, and polybutene is placed in the fitting portion between the positive electrode current collector and the sealing member.

By using the positive electrode current collector of the present invention to produce a manganese dry battery, it is possible to minimize the melting of the paraffin wax itself even when the battery is stored at a high temperature. In particular, when polybutene is used as the sealant for the dry battery, it is possible to prevent the paraffin wax and polybutene from melting and mixing with each other.

In the following, examples of the present invention are described in detail, but it is to be understood that the present invention is not limited to them.

### EXAMPLE 1

A low-quality carbon rod with a low density of 1.62 g/cm³ was prepared by extruding a mixture of graphite and pitch as a binder in a rod. The carbon rod was impregnated with paraffin wax containing a hydrocarbon compound with a melting point listed in Table 1 and a molecular weight of not greater than 310 in an amount listed in Table 1 to give a positive electrode current collector 2 of the present invention.

TABLE 1

| | Density of | Paraffin wax | | Amount of |
|---|---|---|---|---|
| | carbon rod | Melting | Amount in | HC* |
| | (g/cm³) | point (° F.) | carbon rod | (wt %) |
| Comp. Ex. 1 | 1.71 | 135 | 5.0 | 1.5 |
| Comp. Ex. 2 | 1.62 | 135 | 8.5 | 1.5 |
| Comp. Ex. 3 | 1.62 | 145 | 8.4 | 0.8 |
| Ex. 1 | 1.62 | 145 | 8.5 | 0.5 |
| Ex. 2 | 1.62 | 145 | 8.6 | 0.0 |
| Ex. 3 | 1.62 | 155 | 8.7 | 0.0 |
| Ex. 4 | 1.71 | 145 | 5.1 | 0.0 |

*HC = hydrocarbon compound having a molecular weight of not greater than 310

The amount of the hydrocarbon compound having a molecular weight of not greater than 310 and a melting point of not higher than 45° C. in the paraffin wax was determined by gas chromatography. The gas chromatography analysis was performed under the conditions shown in Table 2 using GC17A available from Shimadzu Corporation as an analyzer.

TABLE 2

| Item | | Contents |
|---|---|---|
| Analytical method | | Gas chromatography |
| Equipment | | GC17A from Shimadzu Corp. |
| Column | | Ultra ALLOY-1 from |
| | | Frontier Lab Ltd. |
| | | (30 mm × 0.25 mm |
| | | i.d. df = 0.25 μm) |
| Temperature | Column oven | 50° C. → heated |
| conditions | | (heating rate 15° C./min) |
| | | → 350° C. (maintained for 30 min.) |
| | Vaporizing chamber | 350° C. |
| | Detector | 380° C. |
| Flow | Carrier gas | He |
| conditions | Control mode | Split |
| | Column inlet | 100 kPa |
| | pressure | |
| | Column flow rate | 1.27 ml/min |
| | Column linear | 29.5 cm/s |
| | velocity | |
| | Total volume | 30 ml |
| | Split ratio | 1:20 |
| Detector | Type | FID |
| | ATTEN | 3 |

With the use of the positive electrode current collector 2, an R 20 type manganese dry battery was produced by the following process.

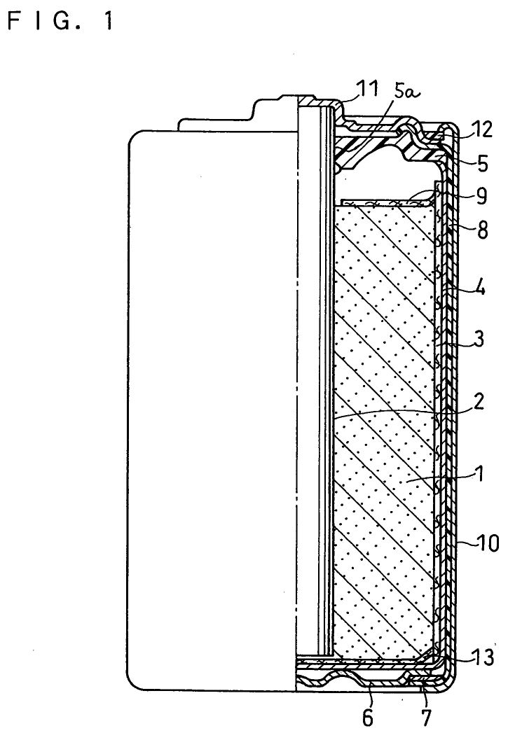

FIG. 1 shows a front view, partly in cross section, of an R 20 type manganese dry battery produced in this example.

A cylindrical positive electrode material mixture 1 was housed in a negative electrode zinc can 4, which was obtained by forming metallic zinc into a bottomed cylindrical case, with a separator 3 interposed therebetween. Inside the positive electrode material mixture 1 was inserted the positive electrode current collector 2 produced above. The positive electrode material mixture 1 and the negative electrode zinc can 4 were isolated by the separator 3. The positive electrode material mixture 1 was prepared by mixing manganese dioxide, conductive carbon black and an electrolyte at a weight ratio of 50:10:40. The electrolyte was made of zinc chloride and water at a weight ratio of 3:7.

A sealing member 5 was formed of polyolefin resin and had an aperture 5a for fitting the positive electrode current collector 2 in the center thereof. When the positive electrode current collector 2 was fitted into the aperture 5a of the sealing member 5, polybutene serving as the sealant was placed in the fitting portion between the sealing member 5 and the positive electrode current collector 2. A Kraft paper 9, that is, a disc-shaped paper with a hole in the center thereof obtained by punching, was placed on the top of the positive electrode material mixture 1. The upper portion of the positive electrode current collector 2 running through the sealing member 5 and the center hole of the Kraft paper 9 was brought into contact with a positive electrode terminal 11 in order for the positive electrode current collector 2 to serve as the current collector for the positive electrode.

The positive electrode terminal 11 made of tinplate comprised a cap-shaped central portion for covering the top of the positive electrode current collector 2 and a flat peripheral portion. An insulating ring 12 made of resin was provided on the edge of the flat peripheral portion of the positive electrode terminal 11. A bottom paper 13 to ensure insulation was placed between the bottom of the positive electrode material mixture 1 and the negative electrode zinc can 4. A sealing ring 7 was placed on the edge of the flat peripheral portion of a negative electrode terminal 6.

A resin tube 8 made of a heat-shrinkable resin film to ensure insulation was provided to entirely cover the negative electrode zinc can 4. The upper portion of the resin tube 8 covered the edge of the sealing member 5 and the lower portion thereof covered the bottom surface of the sealing ring 7.

The resin tube 8 was then completely covered with a cylindrical metal outer jacket 10 made of tinplate. The upper and lower portions of the cylindrical metal outer jacket were respectively bent inward. The tip of the upper portion of the jacket was brought into contact with the insulating ring 12 by the bending. Thereby, the insulating ring 12, the flat peripheral portion of the positive electrode terminal 11, the upper portion of the resin tube 8, the periphery of the sealing member 5 and the opening edge of the negative electrode zinc can 4, as well as the lower portion of the resin tube 8, the sealing ring 7 and the negative electrode terminal 6, were respectively fixed to a certain position.

[Evaluation]

There were produced 100 manganese dry batteries as described above. Immediately after the production, each of the batteries was checked for voltage. After 3 months storage at 45° C., each battery was again checked for voltage. Subsequently, the average of the voltage difference (voltage drop) between the voltage immediately after the production and that after the storage at 45° C. was determined.

There were also produced another 10 manganese dry batteries as described earlier. Each of the batteries was continuously discharged with a load of 2.2 Ω. After 3 months storage at 45° C., each battery was again discharged in the same manner. The discharge was performed in an atmosphere of 20° C.

### EXAMPLES 2 TO 4 AND COMPARATIVE EXAMPLES 1 to 3

An R 20 type manganese dry battery for each example was produced in the same manner as in EXAMPLE 1 except that the combination of paraffin wax and a carbon rod with a density shown in Table 1 was used. A positive electrode current collector and a manganese dry battery obtained here were respectively evaluated in the same manner as in EXAMPLE 1.

The paraffin wax used in each example contained a hydrocarbon compound having a melting point shown in Table 1 and a molecular weight of not greater than 310 in an amount shown in the same table.

Table 3 shows the evaluation results of the batteries of EXAMPLEs 1 to 4 and COMPARATIVE EXAMPLEs 1 to 3.

TABLE 3

| | | Time for continuous discharge at 2.2 Ω | |
|---|---|---|---|
| | | (min.) | |
| | Voltage drop | | After storage |
| | (mV) | Before storage | (remaining ratio) |
| Comp. Ex. 1 | 5 | 583 | 551 (95) |
| Comp. Ex. 2 | 11 | 580 | 528 (91) |
| Comp. Ex. 3 | 7 | 583 | 542 (93) |
| Ex. 1 | 5 | 580 | 551 (95) |
| Ex. 2 | 3 | 581 | 566 (97) |
| Ex. 3 | 3 | 580 | 562 (97) |
| Ex. 4 | 3 | 578 | 560 (97) |

This table indicates that the batteries of EXAMPLEs 1 to 4 having paraffin wax containing a hydrocarbon compound with a molecular weight of not greater than 310 in an amount of 0.5 wt % or lower exhibited better high temperature storage characteristics than those of COMPARATIVE EXAMPLEs 1 to 3.

In the batteries of COMPARATIVE EXAMPLEs 2 and 3, the amount of the component melted out during the high temperature storage increased. This is because a carbon rod with a low density was used in the examples so that each of the batteries was required to have increased amount of paraffin wax contained and thus the amount of the component that melts at 45° C. or lower in the paraffin wax exceeded 0.5 wt %. The sealant composed mainly of polybutene melted and compatibly blended with the melted paraffin wax, which deteriorated its sealing effect. Presumably, these above factors made it easier for air to enter the battery through the pores of the carbon rod, leading to the degradation of the battery.

In the batteries of EXAMPLEs 1 to 3, a carbon rod with a low density was also used so that they also contained an increased amount of the paraffin wax. However, the amount of the component that melts at 45° C. or lower in the paraffin wax was not greater than 0.5 wt %. As a result, the amount of the component melted out during the storage at 45° C. was small, and thus the sealing property of the battery was able to be effectively retained. In other words, the present invention was able to minimize the melting of the paraffin wax and to prevent the paraffin wax and polybutene from melting and compatibly blending with each other in the case of using polybutene as the sealant of the dry battery. Thereby, the sealing effect of the sealant was able to be retained.

As described above, according to the present invention, it is possible to provide a positive electrode current collector for a manganese dry battery having a carbon rod with a low density yet with good retention of the sealing property of the battery during high temperature storage. It is also possible to provide a manganese dry battery with excellent high temperature storage characteristics by using the positive electrode current collector.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

By using the positive electrode current collector of the present invention to produce a manganese dry battery, it is possible to minimize the melting of the paraffin wax itself even when the battery is stored at a high temperature. In particular, when polybutene is used as the sealant for the dry battery, it is possible to prevent the paraffin wax and polybutene from melting and mixing with each other.

1. A positive electrode current collector for a manganese dry battery comprising: a carbon rod, and paraffin wax containing a hydrocarbon compound having a molecular weight of 300 to 500 impregnated in said carbon rod,
said paraffin wax containing a hydrocarbon compound having a molecular weight of not greater than 310 in an amount of not greater than 0.5 wt %.

2. The positive electrode current collector for a manganese dry battery in accordance with claim 1, wherein the amount of said hydrocarbon compound having a molecular weight of not greater than 310 in said paraffin wax is measured by gas chromatography.

3. The positive electrode current collector for a manganese dry battery in accordance with claim 1, wherein said carbon rod has a density of 1.50 to 1.75 g/cm³.

4. A manganese dry battery comprising the positive electrode current collector for a manganese dry battery in accordance with any one of claims 1 to 3.

5. The manganese dry battery in accordance with claim 4, further comprising: a sealing member having an aperture for fitting said positive electrode current collector, and polybutene placed as a sealant in the fitting portion between said positive electrode current collector and said sealing member.
